(19) United States
(12) Patent Application Publication
(10) Pub. No.: US 2008/0143197 A1
(43) Pub. Date: Jun. 19, 2008

(54) Stator structure and manufacturing method thereof

(76) Inventors: Cheng-Hong Lee, Taoyuan Hsien (TW); Yu-Lin Hsueh, Taoyuan Hsien (TW); Yi-Hong Huang, Taoyuan Hsien (TW)

Correspondence Address: BIRCH STEWART KOLASCH & BIRCH, PO BOX 747, FALLS CHURCH, VA, 22040-0747, US

(21) Appl. No.: 11/953,646

(22) Filed: Dec. 10, 2007

(30) Foreign Application Priority Data
Dec. 18, 2006 (TW) 095147373

(51) Int. Cl. H02K 1/12; H02K 15/12; B29C 45/00; H02K 15/02

(52) U.S. Cl. 310/44; 310/254; 264/295; 264/614

(57) ABSTRACT

A stator structure includes a magnetically conductive element and a winding. The magnetically conductive element is integrally formed as a single unit by at least one magnetic powder. The winding is wound around the magnetically conductive element. The manufacturing method of the motor stator is also disclosed.

### CROSS REFERENCE TO RELATED APPLICATIONS

This Non-provisional application claims priority under 35 U.S.C. §119(a) on Patent Application No(s). 095147373 filed in Taiwan, Republic of China on Dec. 18, 2006, the entire contents of which are hereby incorporated by reference.

### BACKGROUND OF THE INVENTION

1. Field of Invention

The invention relates to a stator structure and the magnetically conductive element thereof. In particular, the invention relates to a magnetically conductive element integrally formed as a single unit by using a magnetic powder and the stator structure using the same in a motor.

2. Related Art

The basic structure of a motor includes a stator structure and a rotor structure. With reference to FIG. 1, the conventional stator structure 1 has several silicon steel sheets with permeability stacked together. The silicon steel sheets arc divided into the lower, middle, and upper layers. A winding 12 is wound between the different layers of the silicon steel sheets. The stator structure is disposed on a printed circuit board (PCB) 13.

However, the conventional method of forming the magnetically conductive element of the stator structure is complicated. Therefore, the manufacturing cost is high and the yield and the product quantity are low.

Therefore, it is an important subject of the invention to provide a stator structure and the magnetically conductive element thereof that can reduce the manufacturing cost and enhance the performance of the motor.

### SUMMARY OF THE INVENTION

In view of the foregoing, the invention is to provide a stator structure and the magnetically conductive element thereof. The magnetically conductive element is integrally formed from at least one magnetic powder. It reduces the manufacturing cost, maintains the characteristics, and enhances the performance of the motor.

To achieve the above, the invention discloses a stator structure including a magnetically conductive element and a winding. The magnetically conductive element is integrally formed as a single unit from at least one magnetic powder. The winding winds around the magnetically conductive element.

To achieve the above, the invention also discloses a magnetically conductive element, which is integrally formed as a single unit from at least one magnetic powder.

As mentioned above, the disclosed stator structure and magnetically conductive element of the invention involving at least one magnetic powder (e.g., Fe—Si material) are formed via a molding process, and under predetermined pressure and temperature conditions. The magnetically conductive element is integrally formed as a single unit (by powder metallurgy, thermal press molding or injection molding) after a thermal process. In comparison with the prior art, the integrally formed magnetically conductive element does not involve complicated manufacturing and assembly processes. Therefore, the invention reduces the manufacturing cost. At the same time, the characteristics (such as the DC resistance and core loss) of the motor can be maintained and the performance of the motor can be enhanced.

### BRIEF DESCRIPTION OF THE DRAWINGS

The invention will become more fully understood from the detailed description given herein below illustration only, and thus is not limitative of the present invention, and wherein:

FIG. 1 is a schematic illustration of a conventional stator structure;

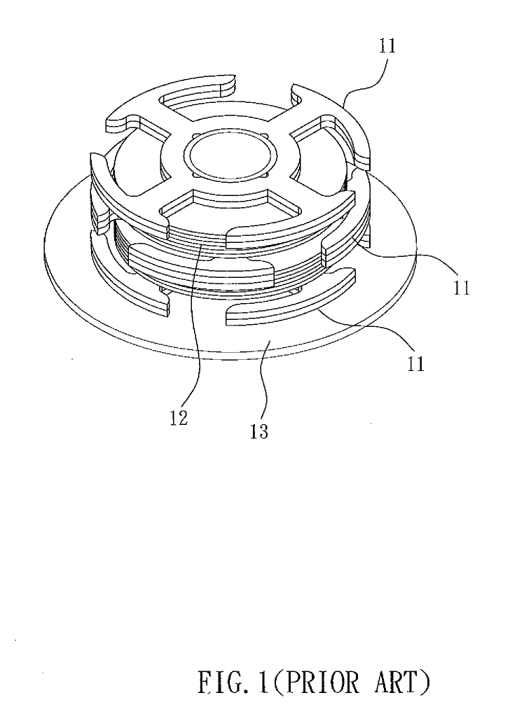

FIG. 2 is a schematic illustration of a stator structure according to an embodiment of the invention;

FIG. 3 is a schematic illustration showing the process of making the stator structure according to the embodiment of the invention;

FIG. 4 shows the first experimental results of the fan that uses the stator structure according to the embodiment of the invention; and

FIG. 5 shows the second experimental results of the fan that uses the stator structure according to the embodiment of the invention.

### DETAILED DESCRIPTION OF THE INVENTION

The present invention will be apparent from the following detailed description, which proceeds with reference to the accompanying drawings, wherein the same references relate to the same elements.

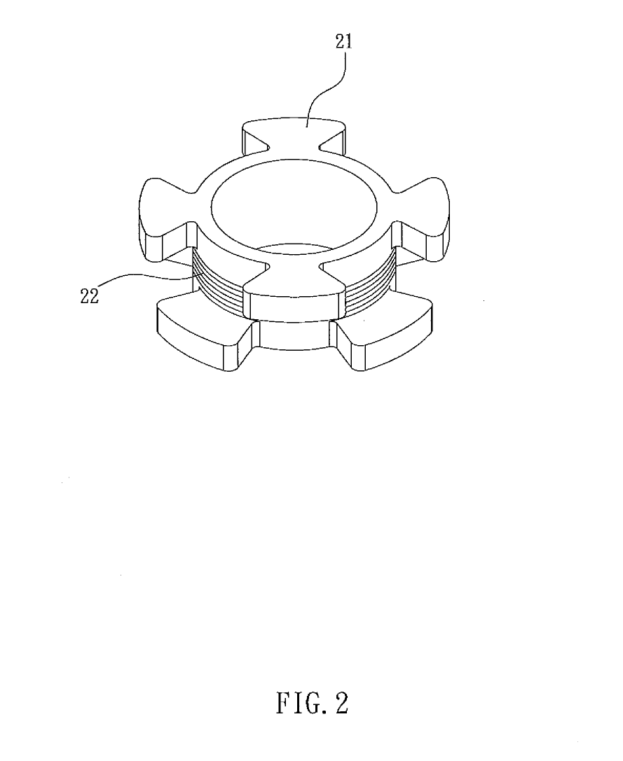

With reference to FIG. 2, the stator structure 2 according to a preferred embodiment of the invention includes a magnetically conductive element 21 and a winding 22. The winding 22 winds around the magnetically conductive element 2l. The magnetically conductive element 21 consists of at least one magnetic powder, such as Fe—Si. The magnetic powder may even include Co, Ni, Al, Mo, W and their alloys.

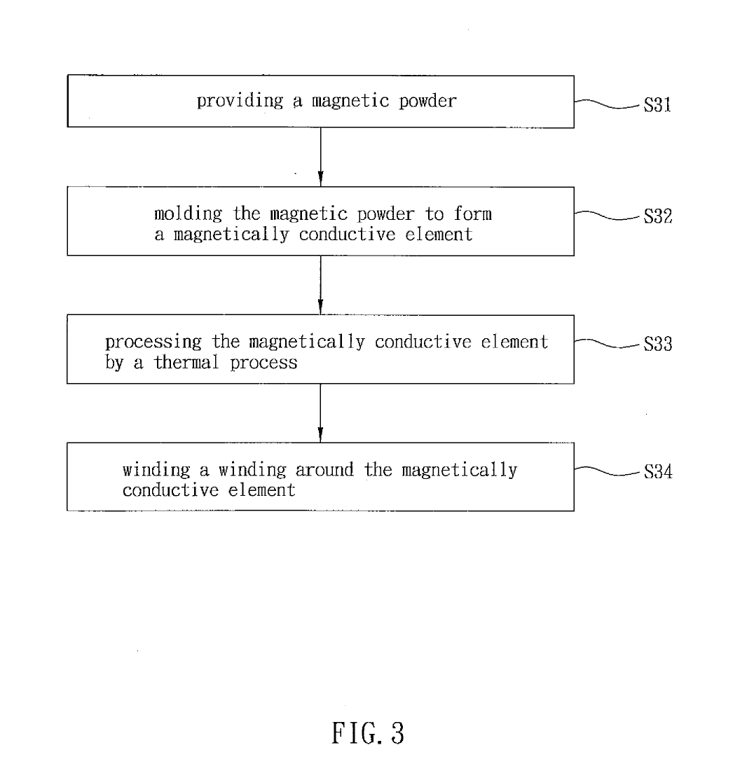

Please refer to FIGS. 2 and 3. The formation of the stator structure 2 includes steps S31 to S34. In step S31, a magnetic powder (e.g., Fe—Si material) is provided as the material for forming the magnetically conductive element 21. The silicon content is from 1% to 6% in weight of the material, and the particle diameter is between 10 μm and 250 μm. In step S32, the magnetically conductive element 21 is formed by molding the magnetic powder. The integral formation can be powder metallurgy, thermal press molding, or injection molding. In the formation method of powder metallurgy or thermal press molding, the molding pressure is 10 ton/cm². The thermal processing can be performed in the environment with a protection gas at the temperature of 700° C. for 30 minutes to form the magnetically conductive element 21. The protection gas is an inert gas, preferably argon (Ar). In the formation method of injection molding, the magnetic powders are mixed with a thermoplastic material. The mixture is injected and cooled to cure. In step S33, a thermal process (sintering process) is processed to make the magnetically conductive element 21 achieve the desired element characteristics. In step S34, the winding 22 winds around the magnetically conductive element 21. This completes the manufacturing of the stator structure 2.

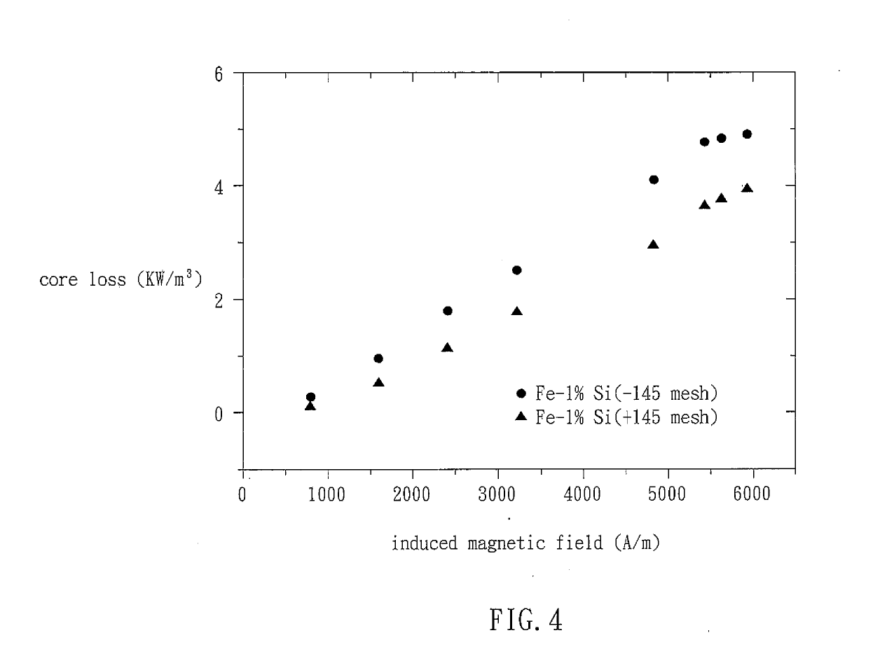

Please refer to Table 1 and FIG. 4. The stator structure 2 is tested with experiments. In the first experiment, a Fe—Si material with 1% Si in weight is used as the magnetic powder. The particle size of powders ranges between 100 μm and 150 μm. The molding pressure is 10 ton/cm². The thermal process conditions is an environment with argon (Ar) at the temperature of 700° C. for 30 minutes (700° C./30 min/Ar) to make the magnetically conductive element 21. Afterwards, a winding 22 with a 0.13 mm diameter winds around the magnetically conductive element 21 for 150 rounds. In comparison with the conventional structure using the silicon steel sheet as the magnetically conductive element, the invention can achieve the similar performance as the conventional motor in the aspects of DC resistance, start voltage, current, and rotation speed (Table 1). Under the induced magnetic field generated by the electrical current of 6000 A/m, the core loss of the present invention is lower than 6 kW/m³ of the conventional motor. Therefore, the present invention is superior to the conventional motor (FIG. 4).

TABLE 1

| | | Start | Working | Rotation speed |
|---|---|---|---|---|
| | DC | voltage | current (A) | (rpm) |
| DC fan stator | resistance | V-start | (operating | (operating |
| structure | (m · ohm) | (V) | voltage 5 V) | voltage 5 V) |
| Conventional | 6.2 | 3.8 | 0.25 | 15126 |
| silicon steel | | | | |
| structure | | | | |
| The present | 6.1 | 3.8 | 0.25 | 15841 |
| invention with | | | | |
| Fe—1% Si and | | | | |
| particle diameter | | | | |
| 150 μm | | | | |
| The present | 5.9 | 3.8 | 0.24 | 15388 |
| invention with | | | | |
| Fe-1% Si and | | | | |
| particle diameter | | | | |
| 100 μm | | | | |

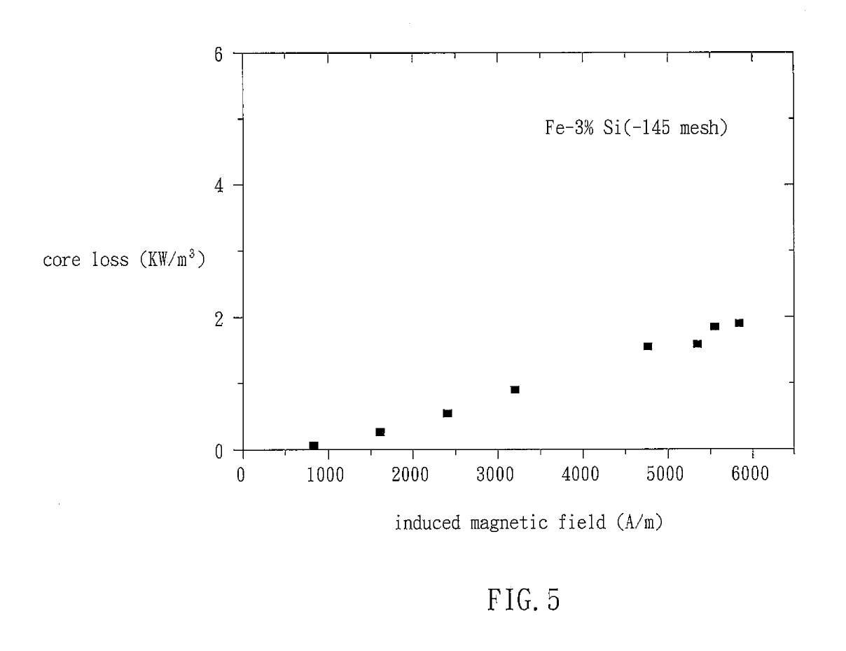

Please refer to Table 2 and FIG. 5. The second experiment uses Fe-3% Si powders with a diameter of 150 μm. The molding pressure is 10 ton/cm². The thermal processing condition is an Ar environment at the temperature of 700° C. for 30 minutes (700° C./30 min/Ar) to make the permeability element 21. Afterwards, a winding 22 of diameter 0.13 mm that winds around the magnetically conductive element 21 for 150 rounds. In comparison with the conventional structure using the silicon steel sheet as the magnetically conductive element, the invention can achieve the similar performance as the conventional motor in the aspects of DC resistance, start voltage, current, and rotation speed (Table 2). Under the induced magnetic field generated by the electrical current of 6000 A/m, the core loss of the invention is much lower than 6 kW/m³ of the conventional motor Therefore, the invention is superior to the conventional motor (FIG. 5).

TABLE 2

| | | Start | Working | Rotation speed |
|---|---|---|---|---|
| | DC | voltage | current (A) | (rpm) |
| DC fan stator | resistance | V-start | (operating | (operating |
| structure | (m · ohm) | (V) | voltage 5 V) | voltage 5 V) |
| Conventional | 6.2 | 3.8 | 0.25 | 15126 |
| silicon steel sheet | | | | |
| The present | 6.1 | 3.8 | 0.23 | 16200 |
| invention with | | | | |
| Fe—3% Si and | | | | |
| particle diameter | | | | |
| 150 μm | | | | |

In summary, the disclosed stator structure and the magnetically conductive element via a molding process thereof involve at least one magnetic powder (e.g., Fe—Si material) formed under predetermined pressure and temperature conditions. The magnetically conductive element is integrally formed as a single unit (by powder metallurgy, thermal press molding or injection molding) after a thermal process. In comparison with the prior art, the integrally formed magnetically conductive element does not involve complicated manufacturing and assembly processes. Therefore, the invention reduces the manufacturing cost. At the same time, the characteristics (such as the DC resistance and core loss) of the motor and the performance of the motor can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A stator structure comprising:
a magnetically conductive element formed from a magnetic powder via a molding process; and
a winding wound around the magnetically conductive element.

2. The stator structure of claim 1, wherein the magnetic powder comprises a Fe—Si material.

3. The stator structure of claim 2, wherein the silicon content of the Fe—Si material is from 1% to 6% in weight

4. The stator structure of claim 2, wherein the magnetic powder further comprises Co, Ni, Al, Mo, W, or their alloys.

5. The stator structure of claim 1, wherein the magnetically conductive element is processed by a thermal process after the molding process.

6. The stator structure of claim 5, wherein the thermal process includes a sintering process.

7. The stator structure of claim 5, wherein the thermal process is performed in an environment with a protection gas.

8. The stator structure of claim 7, wherein the protection gas is an inert gas.

9. The stator structure of claim 8, wherein the inert gas is argon (Ar).

10. The stator structure of claim 5, wherein the thermal process is performed in an argon (Ar) environment at the temperature of 700° C. for 30 minutes.

11. The stator structure of claim 1, wherein the molding process is a powder metallurgy, thermal press molding, or injection molding.

12. The stator structure of claim 11, wherein a pressure of the molding process is 10 ton/cm².

13. The stator structure of claim 1, wherein a particle size of the magnetic powder ranges from 100 μm to 150 μm.

14. A manufacturing method of a stator structure comprising the steps of:
providing a magnetic powder;
molding the magnetic powder to form a magnetically conductive element;
processing the magnetically conductive element by a thermal process; and
winding a winding around the magnetically conductive element.

15. The method of claim 14, wherein the magnetic powder comprises a Fe—Si material.

16. The method of claim 15, wherein the silicon content of the Fe—Si material is from 1% to 6% in weight.

17. The method of claim 15, wherein the magnetic powder further comprises Co, Ni, Al, Mo, W, or their alloys.

18. The method of claim 14, wherein the thermal process includes a sintering process.

19. The method of claim 14, wherein the molding process is a powder metallurgy, thermal press molding, or injection molding.

20. The method of claim 14, wherein the thermal process is performed in an environment with a protection gas.
